(19) United States
(12) Patent Application Publication
(10) Pub. No.: US 2012/0002751 A1
(43) Pub. Date: Jan. 5, 2012

(54) Transmitter, Transmission Method, Receiver, Reception Method, and Program

(76) Inventors: Naohisa Kitazato, Tokyo (JP); Izumi Hatakeyama, Tokyo (JP); Masayuki Obayashi, Kanagawa (JP)

(21) Appl. No.: 13/256,960

(22) PCT Filed: Mar. 24, 2010
(86) PCT No.: PCT/JP2010/055045

§ 371 Date: Sep. 16, 2011

(30) Foreign Application Priority Data
Mar. 27, 2009 (JP) 2009-078222

(51) Int. Cl. H04L 27/06; H04L 27/00

(52) U.S. Cl. 375/295; 375/340

(57) ABSTRACT

A transmitter, a transmission method, a receiver, a reception method, and a program are provided which can allow the acquisition of all selection information of multi-segment broadcasting.

A relevant information generating unit 51 generates an NIT including channel selection information of a central segment of the multi-segment broadcasting and an NIT including channel selection information of non-central segments. A transmitter unit 57 transmits the NIT of the central segment as NIT actual and the NIT of the non-central segments as NIT other through the use of the central segment. This configuration can be applied, for example, to a broadcasting station that transmits the multi-segment broadcasting through the use of terrestrial digital broadcast waves.

### TECHNICAL FIELD

The present invention relates to a transmitter, a transmission method, a receiver, a reception method, and a program, and more particularly, to a transmitter, a transmission method, a receiver, a reception method, and a program which can allow acquisition of overall channel selection information of multi-segment broadcasting.

### BACKGROUND ART

In recent years, terrestrial digital broadcasting has been carried out through a UHF (Ultra High Frequency) band. A physical channel of terrestrial digital broadcasting is divided into 13 segments and broadcasting dedicated to mobile terminals is carried out through the use of a band corresponding to a segment. Broadcasting dedicated to fixed terminals such as television receivers is carried out through the use of bands corresponding to the remaining 12 segments (for example, see PTL 1).

In the broadcasting dedicated to mobile terminals, the same programs as the broadcasting dedicated to fixed terminals are currently broadcast and the mobile terminals receiving the broadcasting dedicated to mobile terminals have been widely spread like mobile phones.

In the terrestrial digital broadcasting waves, many unused channels other than channels through which the terrestrial digital broadcasting is actually carried out in various areas exist among 13 to 52 channels of the UHF band. Accordingly, a method effectively using the unused channels has been studied.

A method of carrying out multi-segment broadcasting through the use of the unused channels is known as a powerful method effectively using the unused channels. Multi-segment broadcasting means plural one-segment broadcast services which are simultaneously sent out through one physical channel. That is, in the multi-segment broadcasting, a frequency band of the terrestrial digital broadcasting is divided into plural segments and one or more broadcast services are provided through one segment.

An existing mobile terminal receiving the broadcasting dedicated to mobile terminals acquires channel selection information which is information on channel selection such as the frequency or the like and creates a table of selection information (hereinafter, referred to as channel selection table).

FIG. 1 is a flowchart illustrating a channel selection table creating process in a mobile terminal according to the related art.

In step S11, the mobile terminal sets a predetermined physical channel (for example, a physical channel having the lowest frequency) as a target physical channel to be processed. In step S12, the mobile terminal selects a central segment of the target physical channel. In step S13, the mobile terminal determines whether a TS (Transport Stream) of the central segment of the target physical channel is received, and performs the process of step S14 when it is determined that the TS is received.

In step S14, the mobile terminal acquires an NIT (Network Information Table) which is information on the network of the corresponding segment described as NIT actual and an SDT (Service Description Table) which is information on a broadcast service of the network of the corresponding segment described as SDT actual from the received TS. The NIT is a table including frequency information for each broadcast service used to tune a carrier with which a specific broadcast service is transmitted and information on the corresponding broadcast service. The SDT is a table including meta-information (for example, a service name) on each broadcast service. After performing the process of step S14, the process of step S15 is performed.

On the other hand, when it is determined in step S13 that the TS of the central segment is not received, the process of step S14 is skipped and the process of step S15 is performed.

In step S15, the mobile terminal determines whether all the physical channels are set as the target physical channel. When it is determined in step S15 that all the physical channels are not set as the target physical channel, the mobile terminal sets a next physical channel (for example, a physical channel having the second highest frequency) as the target physical channel in step S16 and performs the process of step S12 again. The mobile terminal repeatedly performs the processes of steps S12 to S16 until all the physical channels are set as the target physical channel.

On the other hand, when it is determined in step S15 that all the physical channels are set as the target physical channel, the mobile terminal creates a channel selection table on the basis of the NIT and the SDT acquired in step S14, in step S17.

Specifically, as shown in FIG. 2, a network ID which is an ID specific to the network, a TSID which is an ID specific to the TS, a frequency, a service ID specific to the broadcast service, and the like, all of which correspond to the current segment, are described in the NIT. The TSID, the service ID, and the service name corresponding to the service ID, and the like, all of which correspond to the current segment, are described in the SDT.

Accordingly, as shown in FIG. 2, the mobile terminal acquires the service ID and the frequency as the channel selection information from the NIT of the central segment of each physical channel, acquires the service name from the SDT corresponding to the NIT, and correlates them with each other in the channel selection table.

In the example shown in FIG. 2, since two broadcast services of which the service IDs are ID1 and ID2 are time-divisionally transmitted through the central segment of physical channel 1 (physical CH-1), two service IDs are described in the NIT of the central segment of physical channel 1.

### CITATION LIST

### Patent Literature

[PTL 1] JP-A-2007-329847

### SUMMARY OF INVENTION

### Technical Problem

As described above, the mobile terminal according to the related art scans the TS of the central segment of each physical channel and acquires the channel selection information from the NIT of the corresponding segment included in the TS.

Accordingly, when the multi-segment broadcasting is carried out through the use of an unused channel, as shown in FIG. 3, the channel selection information of the central segment 11 of the unused channel can be acquired but the channel selection information of the segments 12-1 to 12-6 other than the central segment 11 cannot be acquired.

The invention is made in consideration of the above-mentioned circumstances and a technical goal thereof is to acquire all the selection information of multi-segment broadcasting.

### Solution to Problem

According to a first aspect of the invention, there is provided a transmitter including: generation means for generating representative channel selection information including information on channel selection of a representative segment of multi-segment broadcasting and non-representative channel selection information including information on channel selection of segments other than the representative segment; and transmission means for transmitting the representative channel selection information and the non-representative channel selection information through the use of the representative segment, or a program allowing a computer to serve as the transmitter.

According to the first aspect of the invention, there is also a transmission method of a transmitter including: a generation step of generating representative channel selection information including information on channel selection of a representative segment of multi-segment broadcasting and non-representative channel selection information including information on channel selection of segments other than the representative segment; and a transmission step of transmitting the representative channel selection information and the non-representative channel selection information through the use of the representative segment.

In the first aspect of the invention, the representative channel selection information including the information on the channel selection of the representative segment of the multi-segment broadcasting and the non-representative channel selection information including the information on the channel selection of the segments other than the representative segment are generated, and the generated representative channel selection information and the generated non-representative channel selection information are transmitted through the use of the representative segment.

According to a second aspect of the invention, there is provided a receiver including: reception means for receiving information, which is transmitted through the use of a representative segment of multi-segment broadcasting, including representative channel selection information including information on channel selection of the representative segment and non-representative channel selection information including information on channel selection of segments other than the representative segment; extraction means for extracting the representative channel selection information and the non-representative channel selection information from the information received by the reception means; and creation means for creating a table of information on the channel selection of the segments of the multi-segment broadcasting on the basis of the representative channel selection information and the non-representative channel selection information extracted by the extraction means, or a program allowing a computer to serve as the receiver.

According to the second aspect of the invention, there is also provided a reception method of a receiver including: a reception step of receiving information, which is transmitted through the use of a representative segment of multi-segment broadcasting, including representative channel selection information including information on channel selection of the representative segment and non-representative channel selection information including information on channel selection of segments other than the representative segment; an extraction step of extracting the representative channel selection information and the non-representative channel selection information from the information received in the reception step; and a creation step of creating a table of information on the channel selection of the segments of the multi-segment broadcasting on the basis of the representative channel selection information and the non-representative channel selection information extracted in the extraction step.

In the second aspect of the invention, the information, which is transmitted through the representative segment of the multi-segment broadcasting, including the representative channel selection information including the information on the channel selection of the representative segment of the multi-segment broadcasting and the non-representative channel selection information including the information on the channel selection of the segments other than the representative segment is received, the representative channel selection information and the non-representative channel selection information are extracted from the received information, and the table of information on the channel selection of the segments of the multi-segment broadcasting is created on the basis of the extracted representative channel selection information and the extracted non-representative channel selection information.

### Advantageous Effects of Invention

As described above, according to the first aspect of the invention, the channel selection information of the representative segment of the multi-segment broadcasting and the channel selection information of the segments other than the representative segment can be transmitted through the use of the representative segment. As a result, the receiver party of the multi-segment broadcasting can acquire all the channel selection information of the multi-segment broadcasting.

According to the second aspect of the invention, it is possible to acquire all the channel selection information of the multi-segment broadcasting.

### BRIEF DESCRIPTION OF DRAWINGS

FIG. 1 is a flowchart illustrating a channel selection table creating process in a mobile terminal according to the related art.

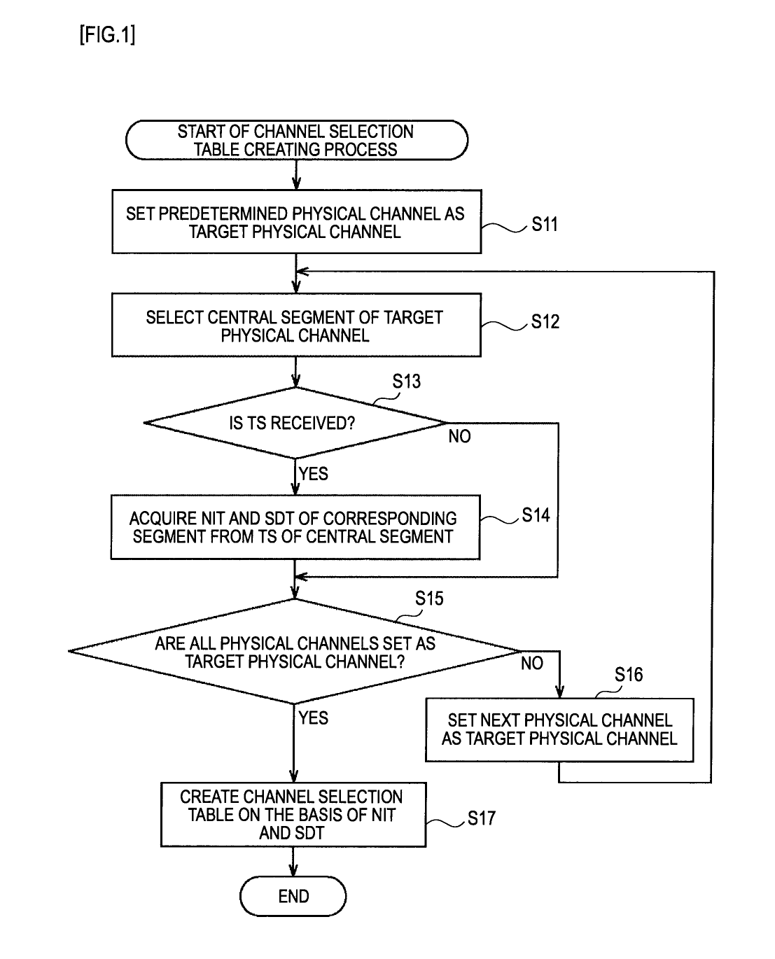

FIG. 2 is a diagram illustrating an example of a channel selection table.

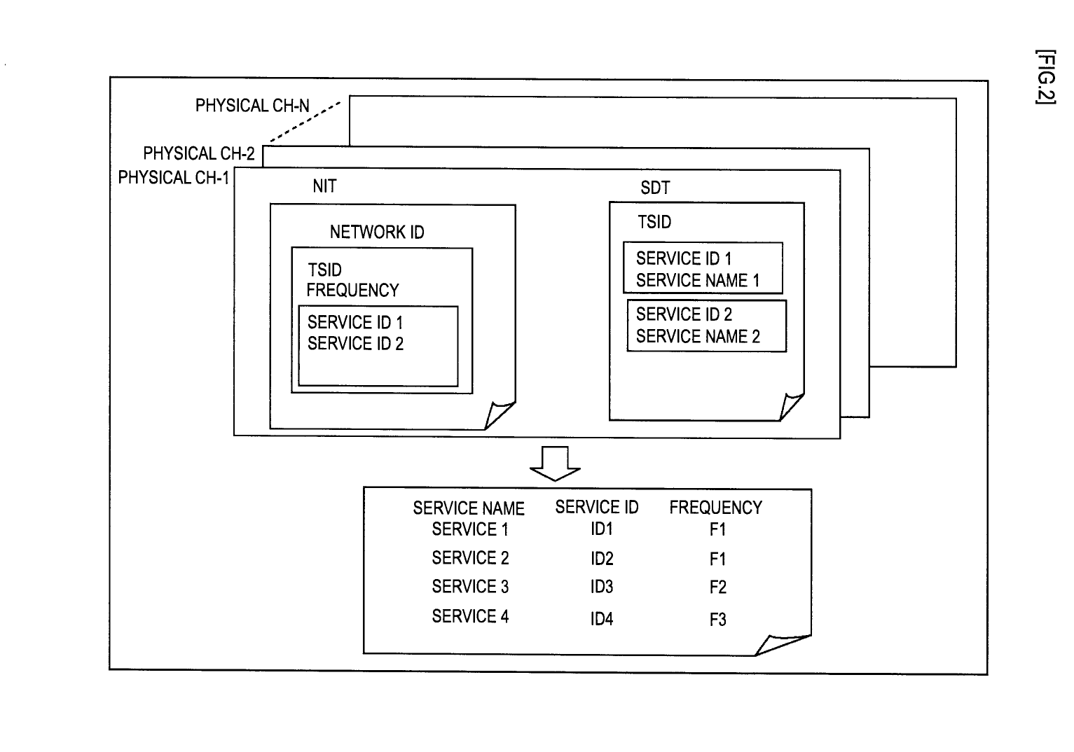

FIG. 3 is a diagram illustrating channel selection information which can be acquired by the mobile terminal according to the related art.

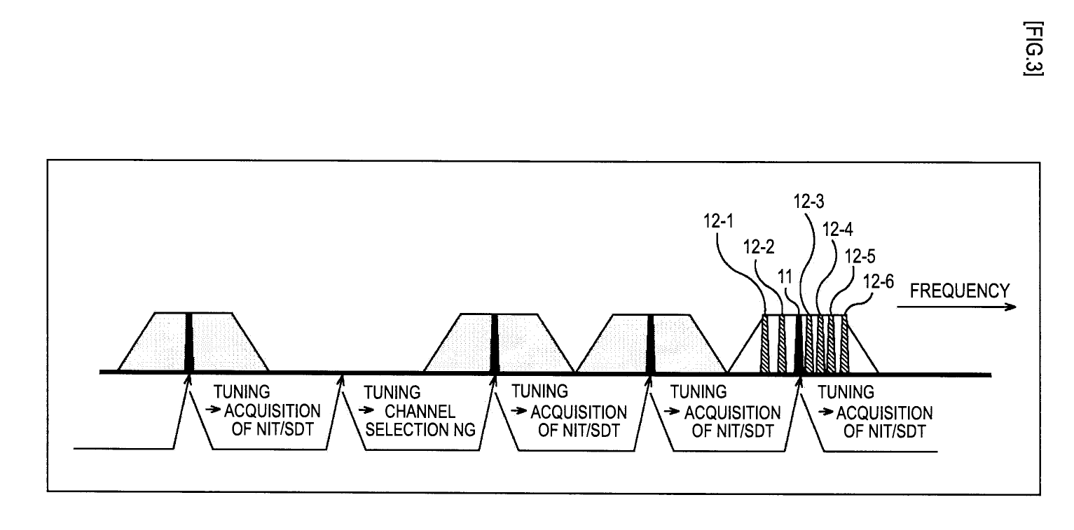

FIG. 4 is a diagram illustrating the configuration of a transmitter and receiver system according to an embodiment of the invention.

FIG. 5 is a diagram illustrating band allocation of terrestrial digital broadcast waves in the transmitter and receiver system shown in FIG. 4.

FIG. 6 is a diagram illustrating the configuration of a transmitter and receiver system according to another embodiment of the invention.

FIG. 7 is a diagram illustrating a method of acquiring channel selection information of community broadcasting.

FIG. 8 is a block diagram illustrating the detailed configuration of a community broadcasting station.

FIG. 9 is a diagram illustrating an NIT transmitted through the use of a central segment of a physical channel for community broadcasting.

FIG. 10 is a diagram illustrating the configurations of an NIT and an SDT of a central segment and a non-central segment.

FIG. 11 is a diagram illustrating the data structure of the NIT.

FIG. 12 is a flowchart illustrating a transmission process of a community broadcasting station.

FIG. 13 is a block diagram illustrating the detailed configuration of a receiver terminal shown in FIG. 4.

FIG. 14 is a diagram illustrating a method of creating a channel selection table in the receiver terminal.

FIG. 15 is a diagram illustrating the receiver terminal according to the related art and the receiver terminal according to the invention.

FIG. 16 is a diagram illustrating an example of a channel selection table.

FIG. 17 is a flowchart illustrating a channel selection table creating process in the receiver terminal.

FIG. 18 is a block diagram illustrating the hardware configuration of a personal computer.

### DESCRIPTION OF EMBODIMENTS

### Embodiment

### Configuration of Transmitter and Receiver System

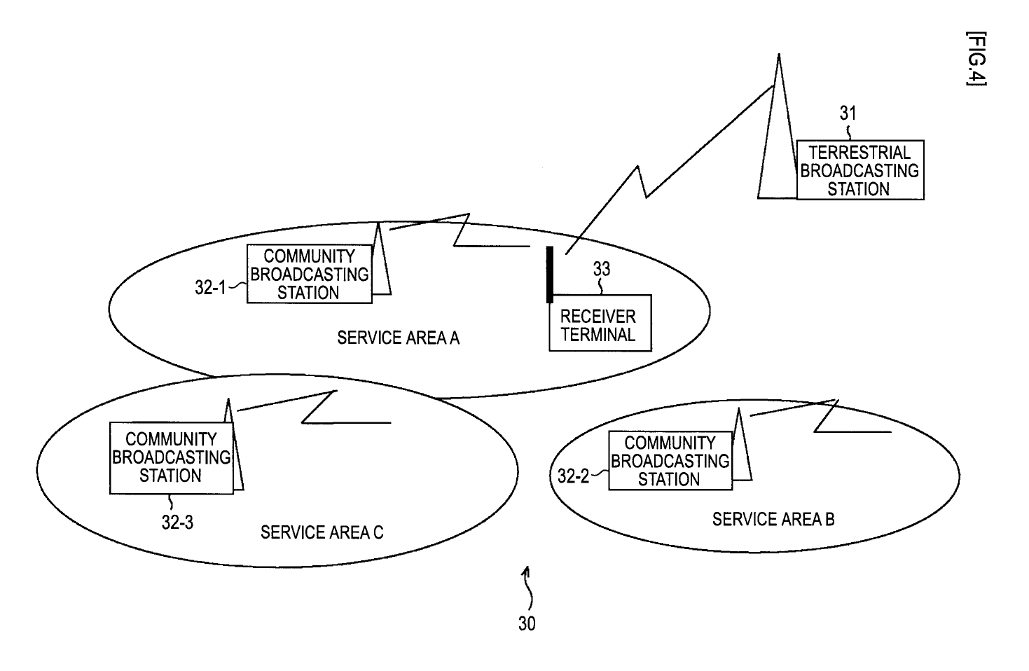

FIG. 4 is a diagram illustrating the configuration of a transmitter and receiver system 30 according to an embodiment of the invention.

The transmitter and receiver system 30 shown in FIG. 4 includes a terrestrial broadcasting station 31, community broadcasting stations 32-1 to 32-3, and a receiver terminal 33.

The terrestrial broadcasting station 31 carries out terrestrial digital broadcasting using terrestrial digital broadcast waves. The community broadcasting station 32-1 transmits multi-channel community broadcasting, which can be received only in service area A, as multi-segment broadcasting using unused channels of the terrestrial digital broadcast waves.

The multi-channel community broadcasting is one-segment broadcasting which is multilaterally carried out using plural logical channels in a defined area. An example of the multi-channel community broadcasting is broadcasting within a theme park which can be received only in the theme park. Hereinafter, the multi-channel community broadcasting is simply referred to as community broadcasting. In the following description, the community broadcasting is exemplified as the multi-segment broadcasting.

The community broadcasting station 32-2 transmits the community broadcasting, which can be received only in service area B, as the multi-segment broadcasting using unused channels of the terrestrial digital broadcast waves. The community broadcasting station 32-3 transmits the community broadcasting, which can be received only in service area C, as the multi-segment broadcasting using unused channels of the terrestrial digital broadcast waves. In the following description, when the community broadcasting stations 32-1 to 32-3 are not particularly necessarily distinguished from each other, they are collectively referred to as the community broadcasting station 32.

The receiver terminal 33 is a mobile terminal which can receive the broadcasting dedicated to mobile terminals (hereinafter, referred to as one-segment broadcasting) of the terrestrial digital broadcasting and the community broadcasting. Accordingly, as shown in FIG. 4, when a user with the receiver terminal 33 is located in service area A, the receiver terminal 33 can receive the one-segment broadcasting and the community broadcasting from the community broadcasting station 32-1.

### Terrestrial Digital Broadcast Wave

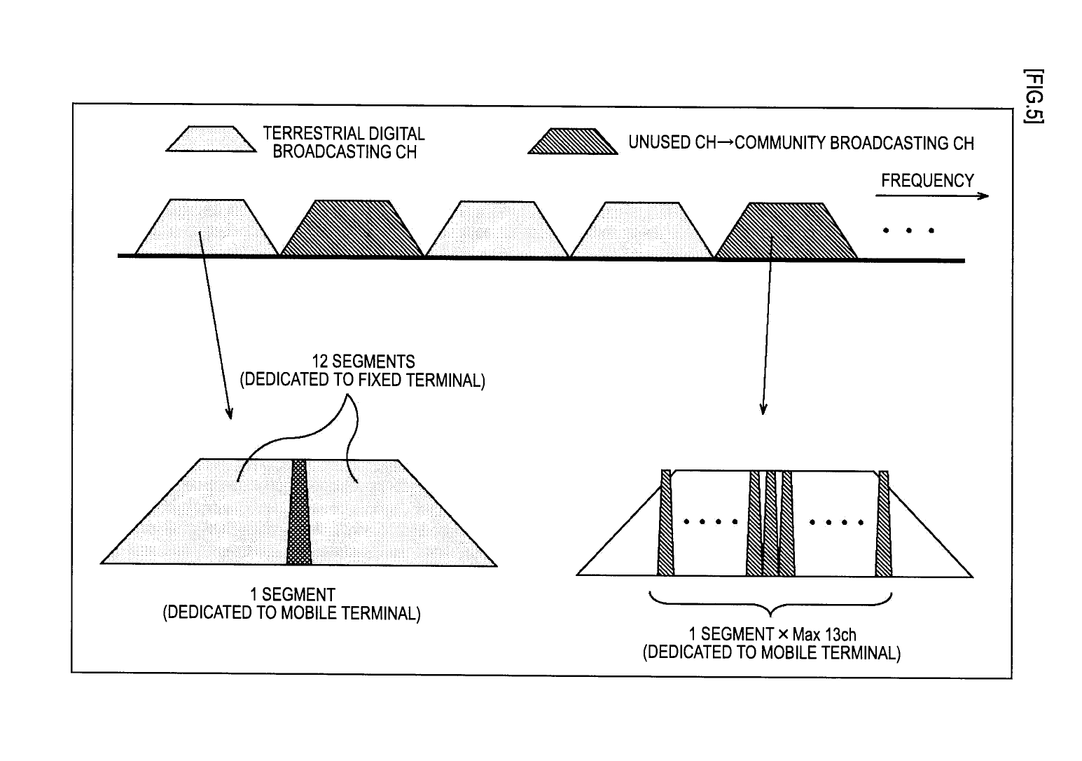

FIG. 5 is a diagram illustrating band allocation of terrestrial digital broadcast waves in the transmitter and receiver system 30 shown in FIG. 4.

As shown in FIG. 5, in the transmitter and receiver system 30, the one-segment broadcasting is performed through the use of a band of a central segment in the physical channel used for the terrestrial digital broadcasting among the entire band of terrestrial digital broadcast waves, and the broadcasting dedicated to fixed terminals is performed through the use of the band corresponding to the remaining 12 segments.

The community broadcasting is transmitted as the multi-segment broadcasting through the use of unused channels. The maximum number of logical channels of the community broadcasting that can be performed through the use of one unused channel is 13.

The band allocation of the community broadcasting in the unused channel is not particularly defined, but when the level of importance of the community broadcasting is clear, the community broadcasting having a high level of importance may be allocated to the central segment. In this case, it is possible to allow the receiver terminal 33 to more satisfactorily receive the community broadcasting having a high level of importance.

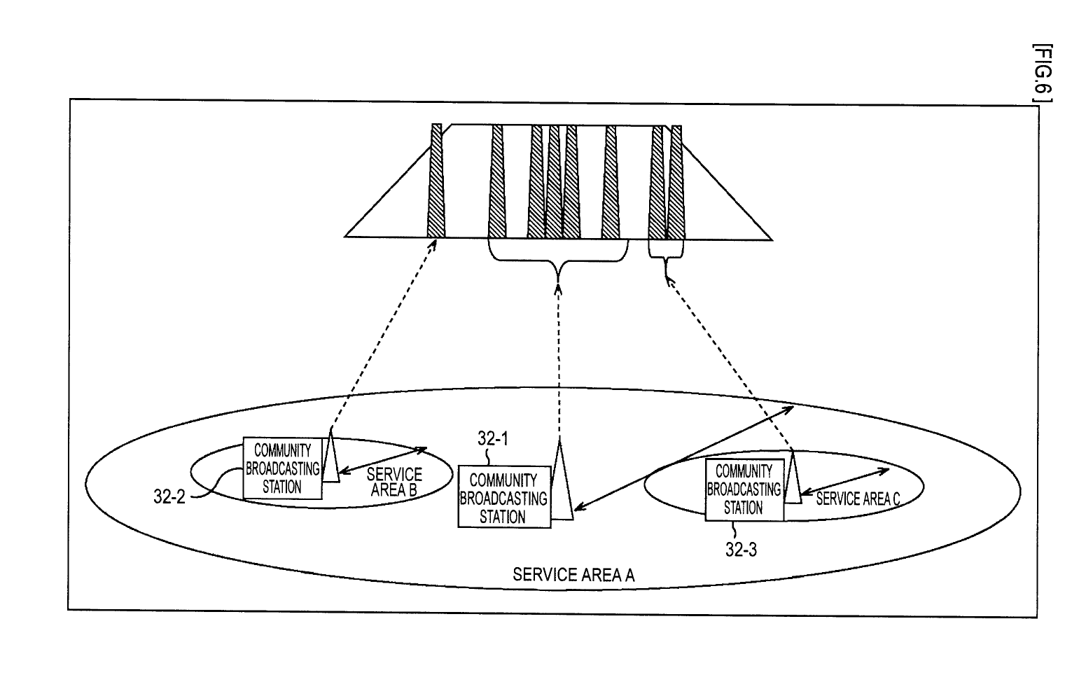

An example where the level of importance of the community broadcasting is clear is shown in FIG. 6. In FIG. 6, the community broadcasting station 32-1 is a central station in which a predetermined area is set as service area A. The community broadcasting stations 32-2 and 32-3 are local stations in which buildings or amusement parts in the area are set as service areas B and C. That is, service area A includes service areas B and C. Accordingly, it is clear that the level of importance of the community broadcasting of the central station (the community broadcasting station 32-1) of which the receivable area is larger is higher than that of the community broadcasting of the local stations (the community broadcasting stations 32-2 and 32-3).

In this case, by allocating the community broadcasting of the community broadcasting station 32-1 as the central station to the central segment, it is possible to allow the receiver terminal 33 to more satisfactorily receive the community broadcasting having a higher level of importance.

### Method of Acquiring Channel Selection Information

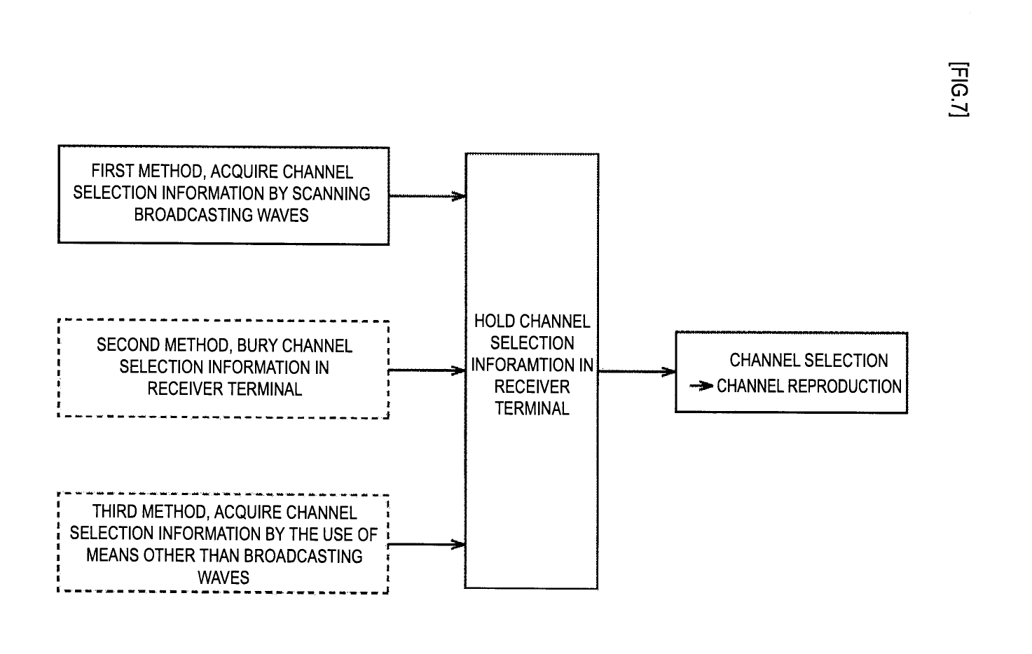

FIG. 7 is a diagram illustrating a method of acquiring channel selection information of community broadcasting in the transmitter and receiver system 30.

As shown in FIG. 7, three methods can be considered as the method of acquiring channel selection information of the community broadcasting. In a first method, the channel selection information is acquired by scanning broadcasting waves. In the first method, a receiver terminal can acquire the channel selection information of receivable community broadcasting by only scanning the terrestrial digital broadcast waves. Accordingly, a user carrying the receiver terminal can automatically acquire the channel selection information of the receivable community broadcasting without recognizing whether there exists community broadcasting receivable at the current position.

In a second method, the channel selection information is buried in the receiver terminal. In the second method, it is necessary to store the channel selection information in the receiver terminal in advance, but it is difficult to store all the channel selection information of the community broadcasting different depending on areas. Accordingly, the second method is not suitable for the community broadcasting.

In a third method, the channel selection information is acquired by the use of means (for example, communication using the Internet) other than the broadcasting. In the third method, the user carrying the receiver terminal needs to grasp whether there exists community broadcasting that can be received at the current position by and to instruct the acquisition of the channel selection information of the community broadcasting. However, it is difficult to grasp the community broadcasting different depending on the areas along with the areas. Accordingly, the third method is not suitable for the community broadcasting.

Accordingly, the first method is employed as the method of acquiring the channel selection information of the community broadcasting in the transmitter and receiver system 30. Specifically, the terrestrial broadcasting station 31 and the community broadcasting station 32 transmit the channel selection information through the use of the terrestrial digital broadcast waves and the receiver terminal 33 acquires and holds the channel selection information through the scanning operation. The receiver terminal 33 selects and reproduces the channel of community broadcasting of a predetermined logical channel on the basis of the held channel selection information.

### Configuration of Community Broadcasting Station

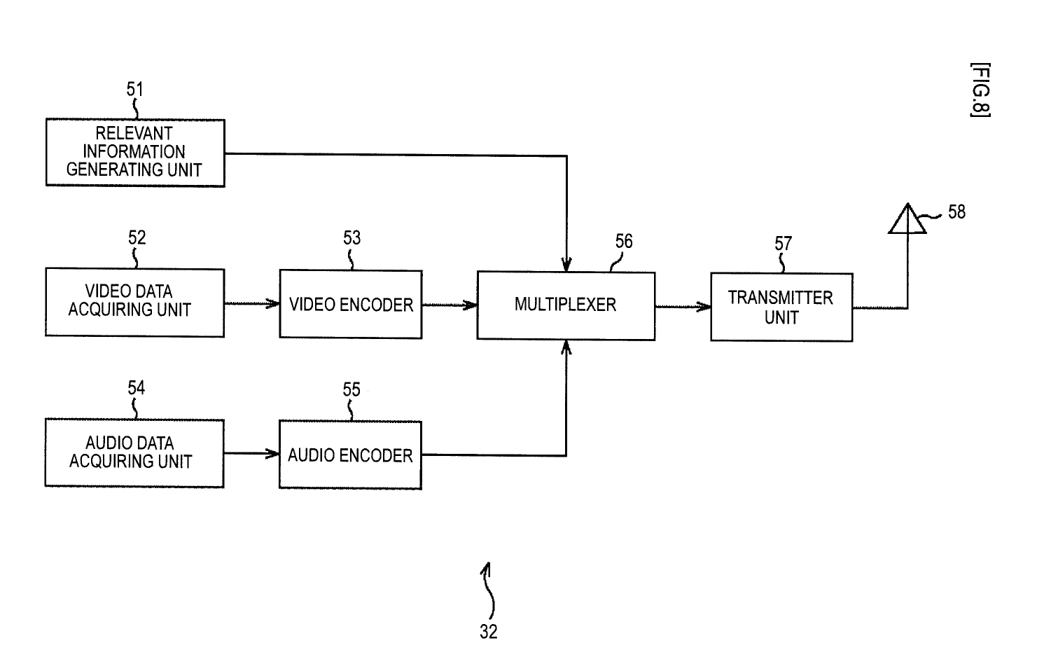

FIG. 8 is a block diagram illustrating the detailed configuration of the community broadcasting station 32.

The community broadcasting station 32 shown in FIG. 8 includes a relevant information generating unit 51, a video data acquiring unit 52, a video encoder 53, an audio data acquiring unit 54, an audio encoder 55, a multiplexer 56, a transmitter unit 57, and an antenna 58.

The relevant information generating unit 51 generates PSI (Program Specific Information) including the NIT and SDT of the community broadcasting and information (hereinafter, referred to as display control information) used to perform a display using a browser in the community broadcasting as relevant information and supplies the relevant information to the multiplexer 56. The PSI is a generic term of tables including information such as an NIT, a PMT (Program Map Table), and a PAT (Program Association Table) used to receive a broadcast service, frequency information, and information used to specify a packet corresponding to the broadcast service and is system control information.

The video data acquiring unit 52 acquires video data of the community broadcasting from a built-in HDD (Hard Disk Drive) not shown or an external server and supplies the acquired video data to the video encoder 53.

The video encoder 53 encodes the video data supplied from the video data acquiring unit 52 on the basis of an encoding method such as MPEG2 (Moving Picture Experts Group Phase 2) and supplies the encoded video data to the multiplexer 56.

The audio data acquiring unit 54 acquires audio data of the community broadcasting from the built-in HDD not shown or the external server and supplies the acquired audio data to the audio encoder 55.

The audio encoder 55 encodes the audio data supplied from the audio data acquiring unit 54 on the basis of the encoding method such as MPEG2 and supplies the encoded audio data to the multiplexer 56.

The multiplexer 56 multiplexes the relevant information from the relevant information generating unit 51, the video data from the video encoder 53, and the audio data from the audio encoder 55, generates a TS, and supplies the generated TS to the transmitter unit 57.

The transmitter unit 57 transmits the TS supplied from the multiplexer 56 via the antenna 58 through the use of a predetermined segment.

### NIT and SDT

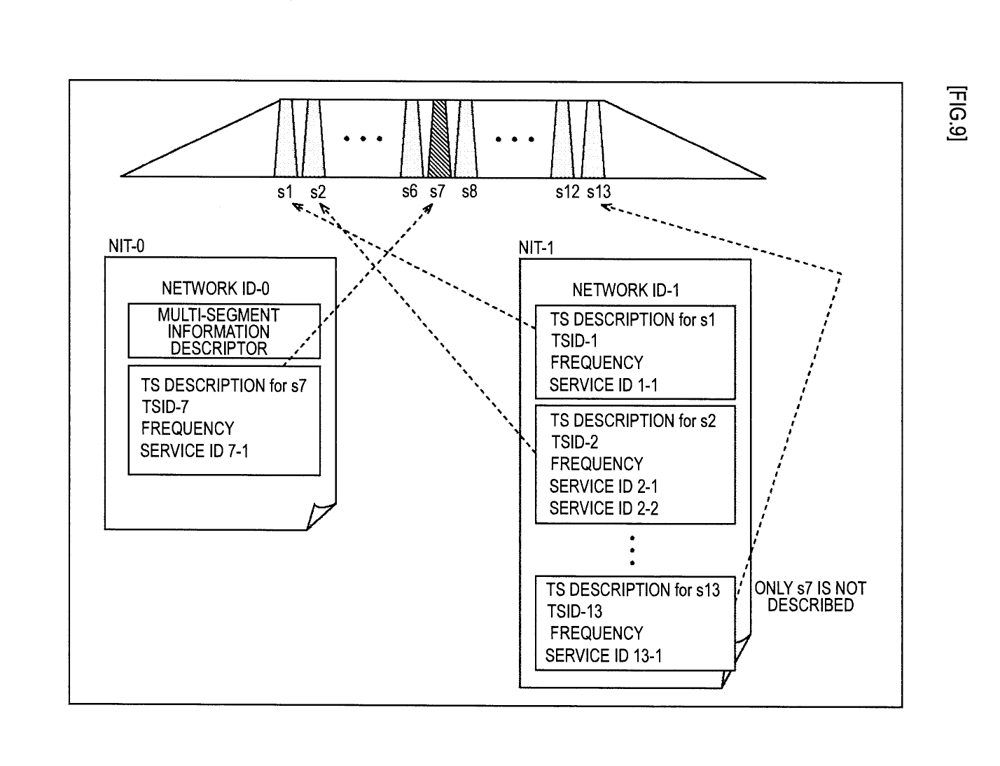

FIG. 9 is a diagram illustrating the NIT supplied through the use of a central segment of a physical channel for the community broadcasting.

As shown in FIG. 9, when the community broadcasting is transmitted through the use of all 13 segments s1 to s13 constituting a physical channel for the community broadcasting, NIT-0 and NIT-1 described below are transmitted through the use of the central segment s7.

NIT-0 includes a network ID, a multi-segment information descriptor, and information (hereinafter, referred to as TS information) on the TS of the central segment s7. The multi-segment information descriptor is a descriptor representing that the segments s1 to s13 constituting the physical channel including the central segment s7 are segments of multi-segment broadcasting. The TS information of the central segment s7 includes a TSID of the TS of the central segment s7, a frequency of the central segment s7, and a service ID of the broadcast service of the central segment s7.

NIT-1 includes a network ID and TS information of the segments s1 to s6 and s8 to s13 other than the central segment s7. The network ID of NIT-0 and the network ID of NIT-1 are different from each other. In the example shown in FIG. 9, the network ID of NIT-0 is 0 and the network ID of NIT-1 is 1.

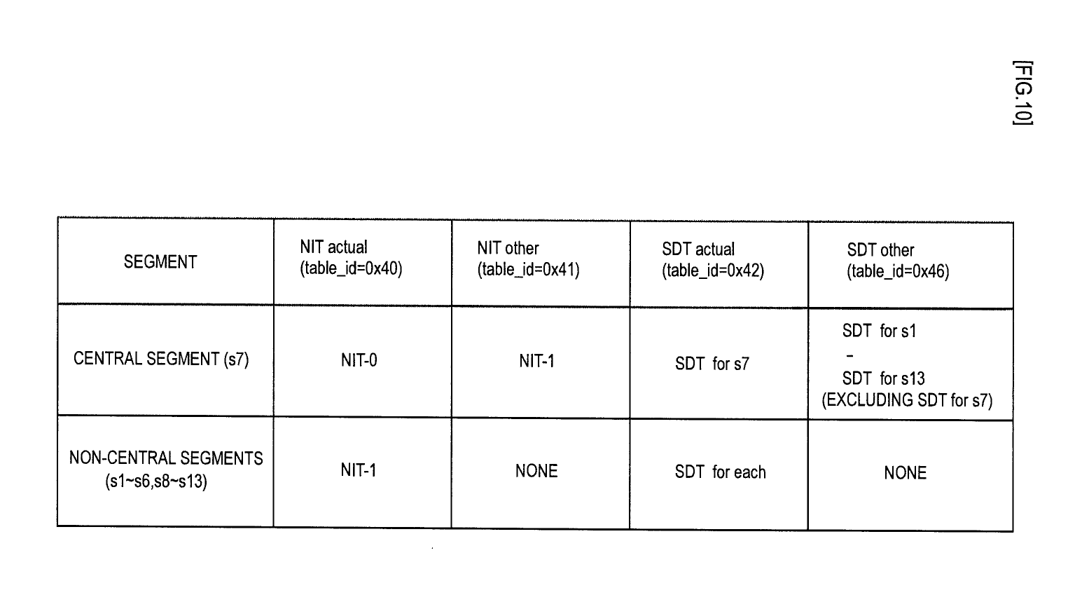

NIT-0 having the above-mentioned configuration is transmitted as NIT actual describing the NIT of the corresponding segment through the use of the central segment s7 as shown in FIG. 10. In addition, NIT-1 is transmitted as NIT other describing the NIT, which is information on the network of the segments (hereinafter, referred to as non-central segments) other than the corresponding segment of the same physical channel.

As shown in FIG. 10, the SDT of the central segment s7 is transmitted as SDT actual describing the SDT of the corresponding segment through the use of the central segment s7. In addition, the SDTs of the non-central segments s1 to s6 and s8 to s13 are transmitted as SDT other describing the SDT, which is information on the broadcasting service of the network of the non-central segments.

On the other hand, as shown in FIG. 10, NIT-1 is transmitted as NIT actual through the use of the non-central segments s1 to s6 and s8 to s13 and nothing is transmitted as NIT other. The SDTs of the corresponding segments s1 to s6 and s8 to s13 are transmitted as SDT actual and nothing is transmitted as SDT other.

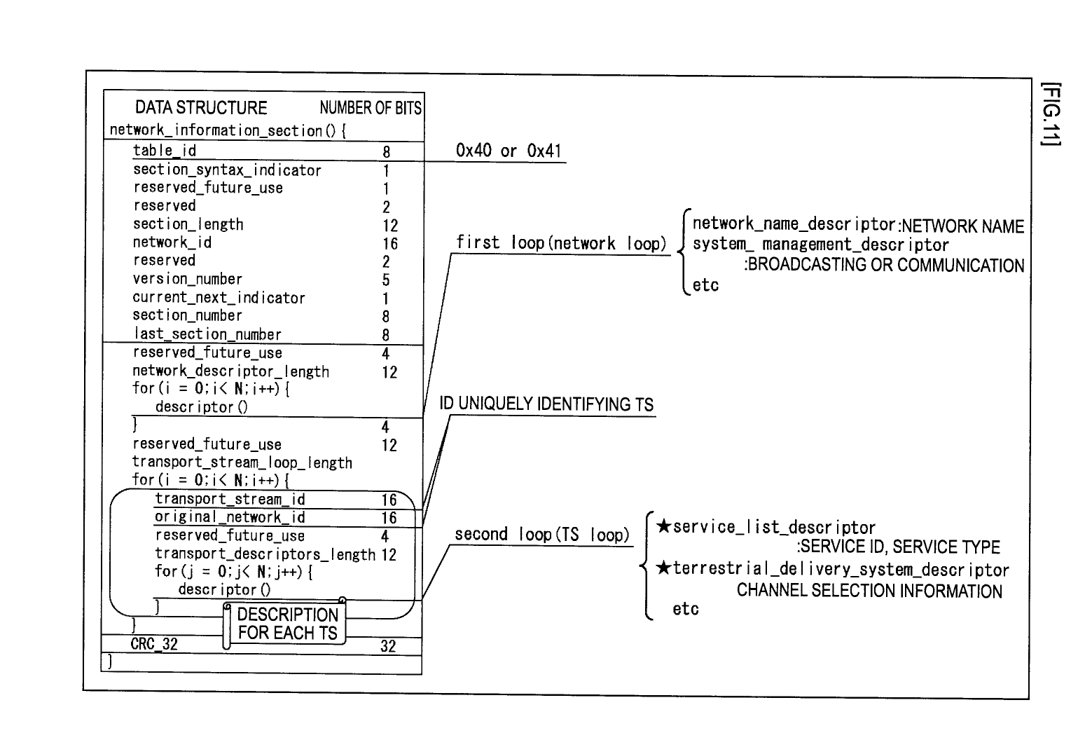

FIG. 11 is a diagram illustrating the data structure of a NIT.

As shown in FIG. 11, a table ID (table_id) of 8 bits, a sectional syntax indicator (section_syntax_indicator) of one bit, and a reserved region (reserved_future_use) of one bit are sequentially arranged from the head of the NIT. When the NIT is an NIT as NIT actual, the table ID is 0x40. When the NIT is an NIT as NIT other, the table ID is 0x41. When the NIT is an NIT as NIT actual of the central segment, the multi-segment information descriptor is described in the reserved future region.

Subsequently to the reserved region, an unused area (reserved) of two bits, a section length (section_length) of 12 bits, a network ID (network_ID) of 16 bits, an unused area (reserved) of two bits, and a version number (version_number) of 5 bits are sequentially arranged. Thereafter, a current next indicator (current_next_indicator) of one bit, a section number (section_number) of 8 bits, a last section number (last_section_number) of 8 bits, and a reserved region of 4 bits are sequentially arranged.

A network descriptor length (network_descriptor_length) of 12 bits and a network loop of 4 bits are sequentially arranged thereafter. In the network loop, descriptors such as a network name descriptor (network_name_descriptor) and a system management descriptor (system_management_descriptor) are arranged for each network ID described in the previous stage. A network name is described in the network name descriptor and information representing whether the network is a broadcast network or a communication network is described in the system management descriptor.

Subsequently to the network loop, a reserved region of 12 bits, a TS loop length (transport_stream_loop_length), a TS loop, and CRC (Cyclic Redundancy Check) 32 values (CRC_{—}32) of 32 bits are sequentially arranged. In the TS loop, a service list descriptor (service_list_descriptor), a terrestrial system descriptor (terrestrial_delivery_system_descriptor), and the like are described for each TS. A service ID which is information for specifying a broadcast service and a service type representing the type of the broadcast service (television broadcasting, radio broadcasting, and the like) are described in the service list descriptor, and the channel selection information is described in the terrestrial system descriptor.

### Processes in Community Broadcasting Station

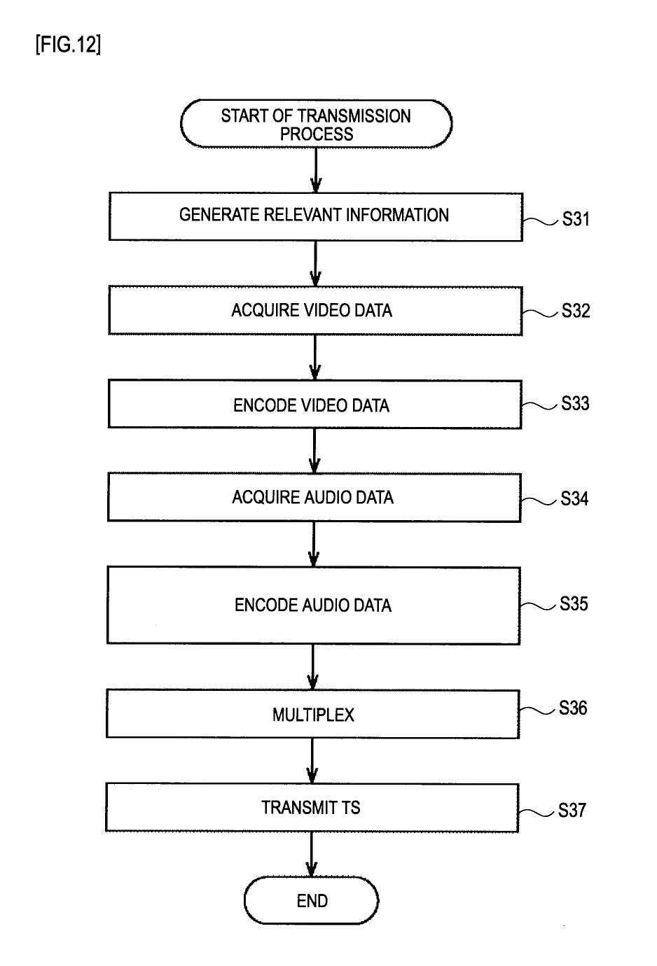

FIG. 12 is a flowchart illustrating a transmission process in the community broadcasting station 32.

In step S31, the relevant information generating unit 51 generates the PSI of the community broadcasting and the display control information as relevant information and supplies the generated relevant information to the multiplexer 56.

In step S32, the video data acquiring unit 52 acquires the video data of the community broadcasting from the built-in HDD not shown or the external server and supplies the acquired video data to the video encoder 53.

In step S33, the video encoder 53 encodes the video data supplied from the video data acquiring unit 52 on the basis of the encoding method such as MPEG2 and supplies the encoded video data to the multiplexer 56.

In step S34, the audio data acquiring unit 54 acquires the audio data of the community broadcasting from the built-in HDD not shown or the external server and supplies the acquired audio data to the audio encoder 55.

In step S35, the audio encoder 55 encodes the audio data supplied from the audio data acquiring unit 54 on the basis of the encoding method such as MPEG2 and supplies the encoded audio data to the multiplexer 56.

In step S36, the multiplexer 56 multiplexes the relevant information from the relevant information generating unit 51, the video data from the video encoder 53, and the audio data from the audio encoder 55 and generates a TS.

Specifically, the multiplexer 56 generates as the TS of the central segment a TS including NIT-0 (see FIG. 9) as NIT actual, including NIT-1 as NIT other, including the SDT of the corresponding segment as SDT actual, and including the SDT of the non-central segments as SDT other. The multiplexer 56 generates as the TS of the non-central segments a TS including NIT-1 as NIT actual and including the SDT of the corresponding segment as SDT actual. The multiplexer 56 supplies the generated TS to the transmitter unit 57.

In step S37, the transmitter unit 57 transmits the TS supplied from the multiplexer 56 via the antenna 58 through the use of a predetermined segment and ends the flow of processes.

### Detailed Configuration of Receiver Terminal

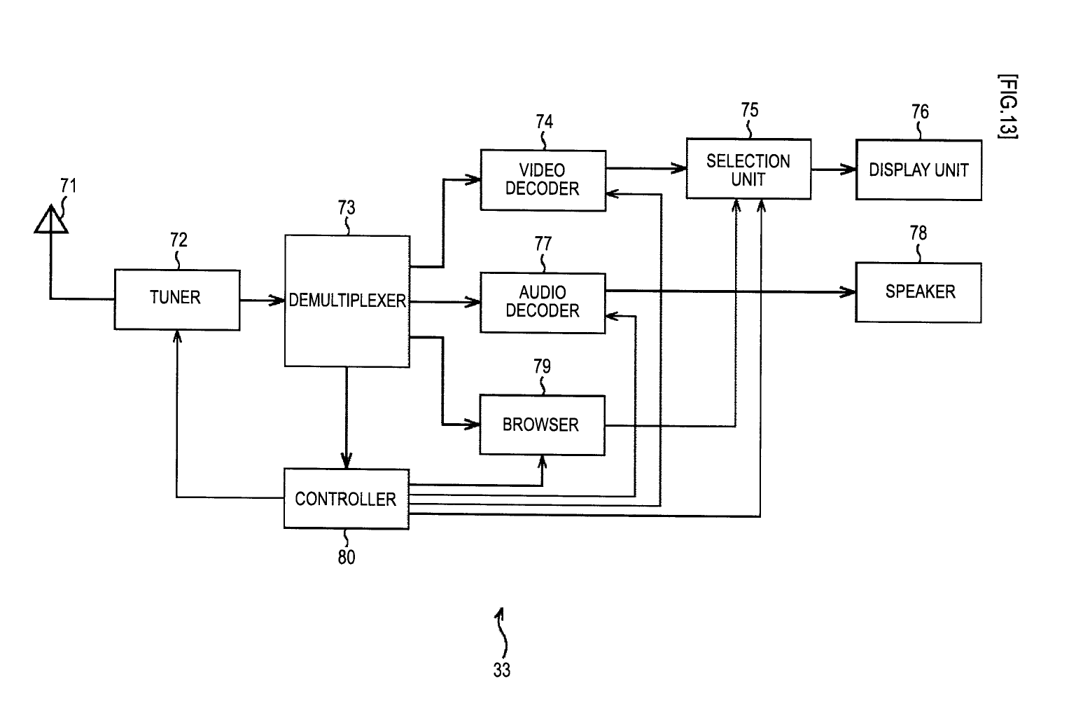

FIG. 13 is a block diagram illustrating the detailed configuration of the receiver terminal 33 shown in FIG. 4.

In FIG. 13, the receiver terminal 33 includes an antenna 71, a tuner 72, a demultiplexer 73, a video decoder 74, a selection unit 75, a display unit 76, an audio decoder 77, a speaker 78, a browser 79, and a controller 80.

The tuner 72 selects a channel on the basis of the channel selection information supplied from the controller 80 and receives the TS of the one-segment broadcasting or the community broadcasting through a predetermined logical channel via the antenna 71 from the terrestrial broadcasting station 31 or the community broadcasting station 32. The tuner 72 supplies the received TS to the demultiplexer 73.

The demultiplexer 73 divides the TS supplied from the tuner 72 into the video data, the audio data, the display control information, and the information of the PSI. The demultiplexer 73 supplies the video data to the video decoder 74 and supplies the audio data to the audio decoder 77. The demultiplexer 73 supplies the display control information to the browser 79 and supplies the information of the PSI to the controller 80.

The video decoder 74 decodes the video data supplied from the demultiplexer 73 on the basis of the method corresponding to the video encoder 53 under the control of the controller 80 and supplies the decoded video data to the selection unit 75.

The selection unit 75 selects the video data supplied from the video decoder 74 or the video data supplied from the browser 79 under the control of the controller 80 and supplies the selected video data to the display unit 76. The display unit 76 displays the image of the one-segment broadcasting or the community broadcasting on the basis of the video data supplied from the selection unit 75.

The audio decoder 77 decodes the audio data supplied from the demultiplexer 73 on the basis of the method corresponding to the audio encoder 55 under the control of the controller 80 and supplies the decoded audio data to the speaker 78. The speaker 78 outputs the sound corresponding to the audio data from the audio decoder 77 as sound of the one-segment broadcasting or the community broadcasting.

The browser 79 analyzes the display control information supplied from the demultiplexer 73, generates the video data, and supplies the generated video data to the selection unit 75.

The controller 80 sequentially supplies the channel selection information of the central segment of each physical channel of the terrestrial digital broadcast waves to the tuner 72. The controller 80 generates the channel selection table on the basis of NIT actual and SDT actual of the central segment of each physical channel supplied from the demultiplexer 73, or NIT actual, NIT other, SDT actual, and SDT other. The controller 80 stores the generated channel selection table in a built-in memory (not shown).

The controller 80 supplies the service names registered in the channel selection table to the browser 79 in response to a command from a user and displays the service names on the display unit 76. The user selects and instructs the service name of the broadcast service to be viewed while viewing the service names displayed on the display unit 76. The controller 80 reads the channel selection information corresponding to the service name to be viewed from the channel selection table on the basis of the selection command and supplies the read channel selection information to the tuner 72.

The controller 80 controls the video decoder 74, the selection unit 75, the audio decoder 77, and the browser 79 on the basis of the information of the PSI supplied from the demultiplexer 73. Specifically, the controller 80 controls the video decoder 74 and the audio decoder 77, for example, to synchronize the video data output from the video decoder 74 and the audio data output from the audio decoder 77 with each other.

### Method of Creating Channel Selection Table

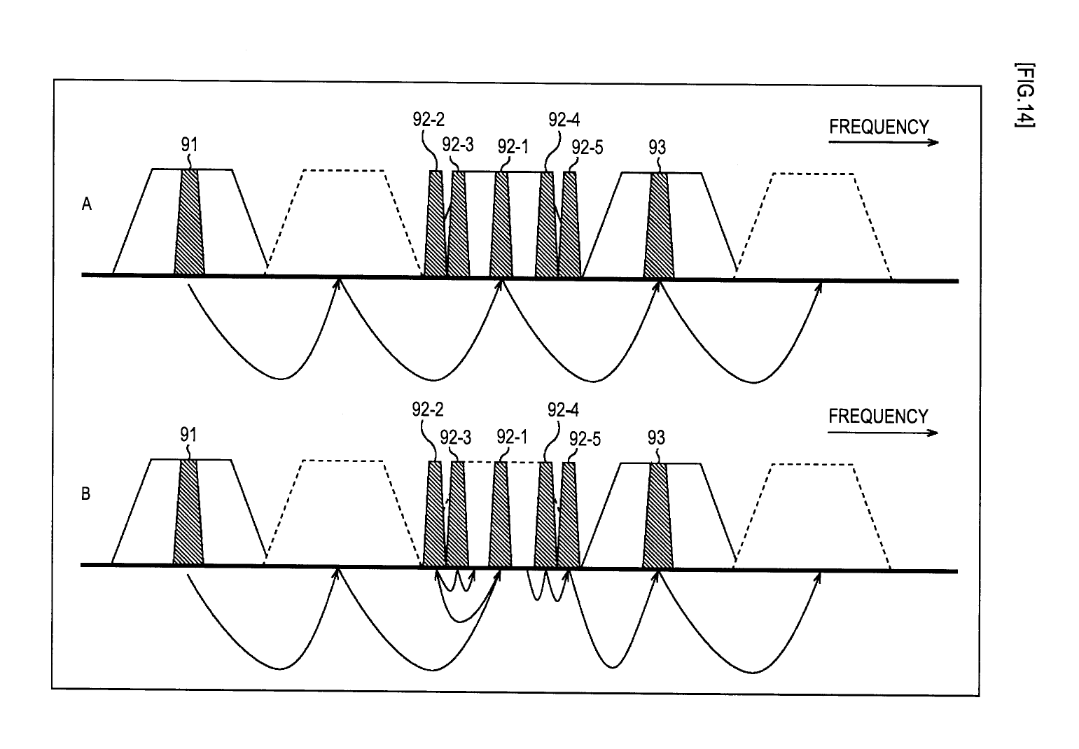

FIG. 14 is a diagram illustrating a method of creating a channel selection table in the receiver terminal 33.

As shown in A of FIG. 14, the receiver terminal 33 scans the central segment of each physical channel of the terrestrial digital broadcast waves sequentially from the low frequency. Specifically, the tuner 72 of the receiver terminal 33 selects the central segment of each physical channel sequentially from the low frequency and acquires the TS of the central segment.

Accordingly, the NIT and SDT of the one-segment broadcasting transmitted through the use of the central segments 91 and 93 are acquired from NIT actual and SDT actual of the TS of the central segments 91 and 93 of the physical channels to which the terrestrial digital broadcasting is allocated.

On the other hand, the NIT and SDT of the community broadcasting transmitted through the use of the central segment 92-1 are acquired from NIT actual and SDT actual of the TS of the central segment 92-1 of the physical channel to which the community broadcasting is allocated. The NITs and SDTs of the community broadcasting allocated to four the non-central segments 92-2 to 92-5 are acquired from NIT other and SDT other of the TS of the central segment 92-1. The channel selection table including the channel selection information of the one-segment broadcasting and the community broadcasting is created using the NITs and SDTs acquired in this way.

As described above, since NIT other and SDT other as well as NIT actual and SDT actual are disposed in the TS of the central segment 92-1, the receiver terminal 33 can acquire the NITs and the SDTs of all the community broadcasting of the physical channel corresponding to the central segment 92-1, by only sequentially scanning the central segments of the physical channels. Accordingly, the receiver terminal 33 can create the channel selection table including the channel selection information of the one-segment broadcasting and the community broadcasting for a short time. As a result, it is possible to rapidly provide the user with the service names of the selectable broadcast services.

On the other hand, the scanning operation for creating the channel selection table when NIT other and SDT other are not disposed in the TS of the central segment is shown in B of FIG. 14. That is, as shown in B of FIG. 14, when the receiver terminal recognizes that the received TS is the TS of the central segment of the multi-segment broadcasting on the basis of the multi-segment information descriptor of NIT actual, the receiver terminal needs to sequentially scan the TS of the non-central segments and to acquire NIT actual and SDT actual of the non-central segments. Accordingly, in this case, the scanning time is elongated and thus it is not efficient.

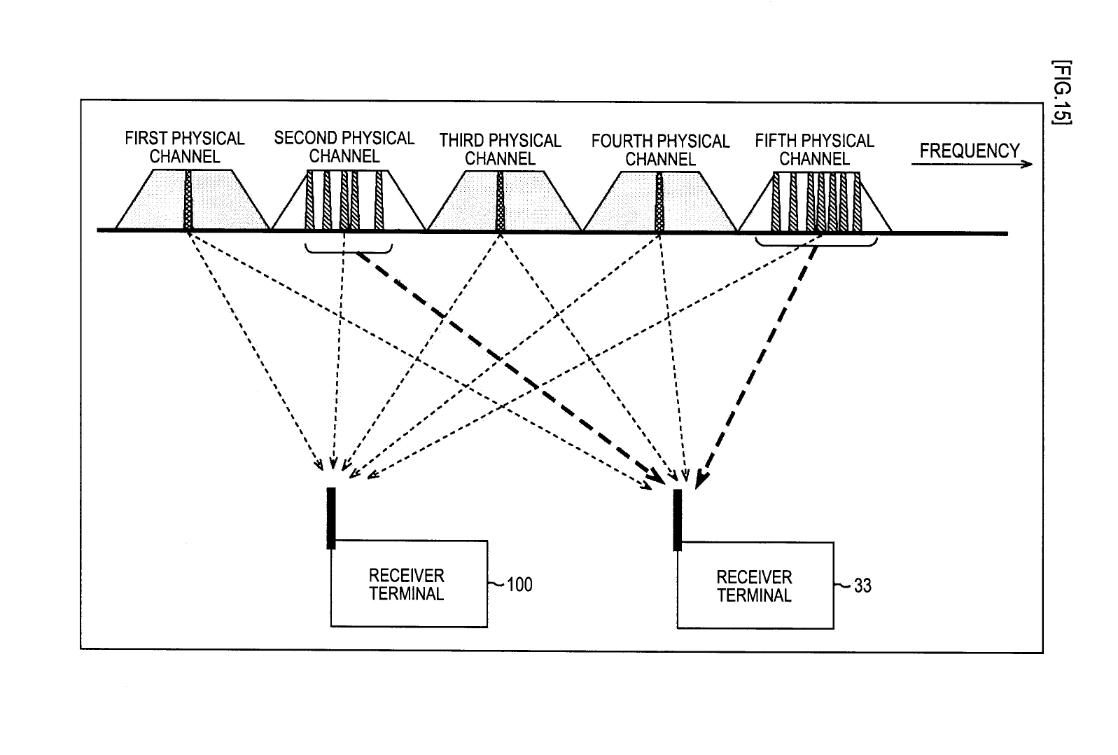

FIG. 15 is a diagram illustrating an existing receiver terminal 100 not coping with the community broadcasting and the receiver terminal 33, which receive the terrestrial digital broadcasting in the transmitter and receiver system 30.

The existing receiver terminal 100 scans the central segments of the physical channels sequentially from the low frequency, similarly to the receiver terminal 33 and creates the channel selection table. However, since the receiver terminal 100 does not cope with the community broadcasting, the multi-segment information descriptor of NIT actual disposed in the TS of the central segment of the physical channel to which the community broadcasting is allocated is neglected. Accordingly, the receiver terminal 100 does not cause an erroneous operation but cannot acquire NIT other and SDT other.

As a result, when the receiver terminal 100 receives the terrestrial digital broadcasting in the transmitter and receiver system 30, the channel selection table is created from the NITs and SDTs of the one-segment broadcasting and the community broadcasting of the central segments of the physical channels, as shown in FIG. 15.

On the contrary, since the receiver terminal 33 copes with the community broadcasting, the receiver terminal can recognize the multi-segment information descriptor of NIT actual disposed in the TS of the central segment of the physical channel to which the community broadcasting is allocated and can acquire NIT other and SDT other. As a result, the receiver terminal 33 creates the channel selection table on the basis of the NITs and the SDTs of all the one-segment broadcasting and the community broadcasting allocated to the physical channels.

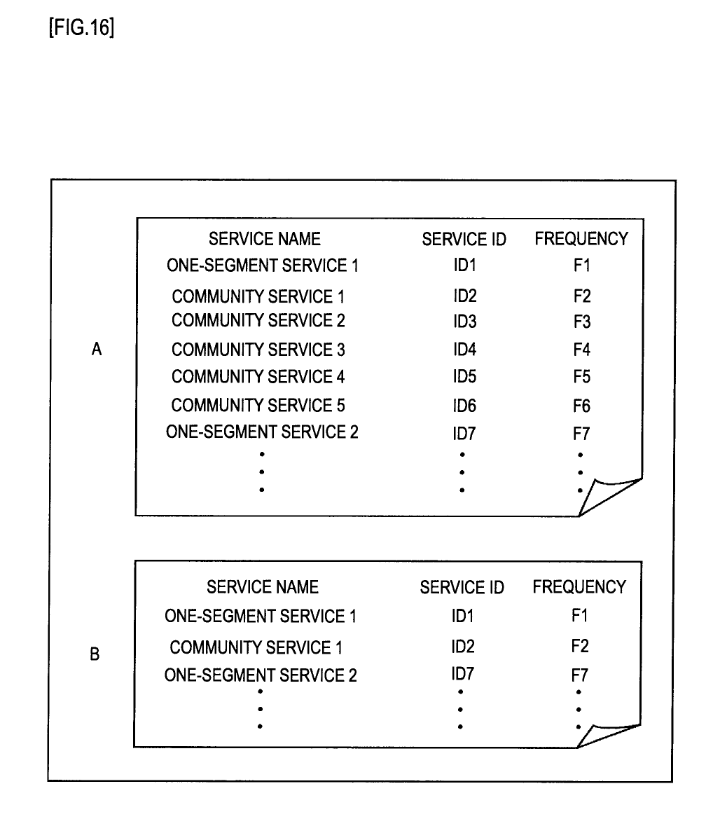

FIG. 16 is a diagram illustrating examples of the channel selection table created by the receiver terminal 33 and the channel selection table created by the receiver terminal 100 in the example shown in FIG. 15.

As shown in A of FIG. 16, first, the service name “one-segment service 1”, the service ID “ID1”, and the frequency “F1” of the one-segment broadcasting allocated to the central segment of the first physical channel are registered in the channel selection table created by the receiver terminal 33.

The service names “community service 1” to “community service 5”, the service IDs “ID2” to “ID6”, and the frequencies “F2” to “F6” of the community broadcasting allocated to five segments of the second physical channel are then registered.

The service name “one-segment service 2”, the service ID “ID7”, and the frequency “F7” of the one-segment broadcasting allocated to the central segment of the third physical channel are then registered. Thereafter, similarly, the service names, the service IDs, and the frequencies of the one-segment broadcasting allocated to the central segment of the fourth physical channel and the community broadcasting allocated to seven segments of the fifth physical channel are registered.

On the other hand, as shown in B of FIG. 16, similarly to the channel selection table created by the receiver terminal 33, the service name “one-segment service 1”, the service ID “ID1”, and the frequency “F1” of the one-segment broadcasting allocated to the central segment of the first physical channel are registered in the channel selection table created by the receiver terminal 100.

The service name “community service 1”, the service ID “ID2”, and the frequency “F2” of the community broadcasting allocated to the central segment of the second physical channel are then registered.

Similarly to the channel selection table created by the receiver terminal 33, the service name “one-segment service 2”, the service ID “ID7”, and the frequency “F7” of the one-segment broadcasting allocated to the central segment of the third physical channel are then registered. Thereafter, similarly, the service names, the service IDs, and the frequencies of the one-segment broadcasting allocated to the central segment of the fourth physical channel and the community broadcasting allocated to the central segment of the fifth physical channel are registered.

As described hitherto, when the existing receiver terminal 100 receives the terrestrial digital broadcasting in the transmitter and receiver system 30, the receiver terminal 100 does not cope with the community broadcasting and thus cannot register the channel selection information of the community broadcasting of the non-central segments in the channel selection table. However, the existing receiver terminal 100 can acquire the channel selection information of the one-segment broadcasting transmitted from the terrestrial broadcasting station 31. Accordingly, the terrestrial digital broadcasting according to the invention does not hinder the reception of the one-segment broadcasting in the existing receiver terminal 100.

### Processes in Receiver Terminal

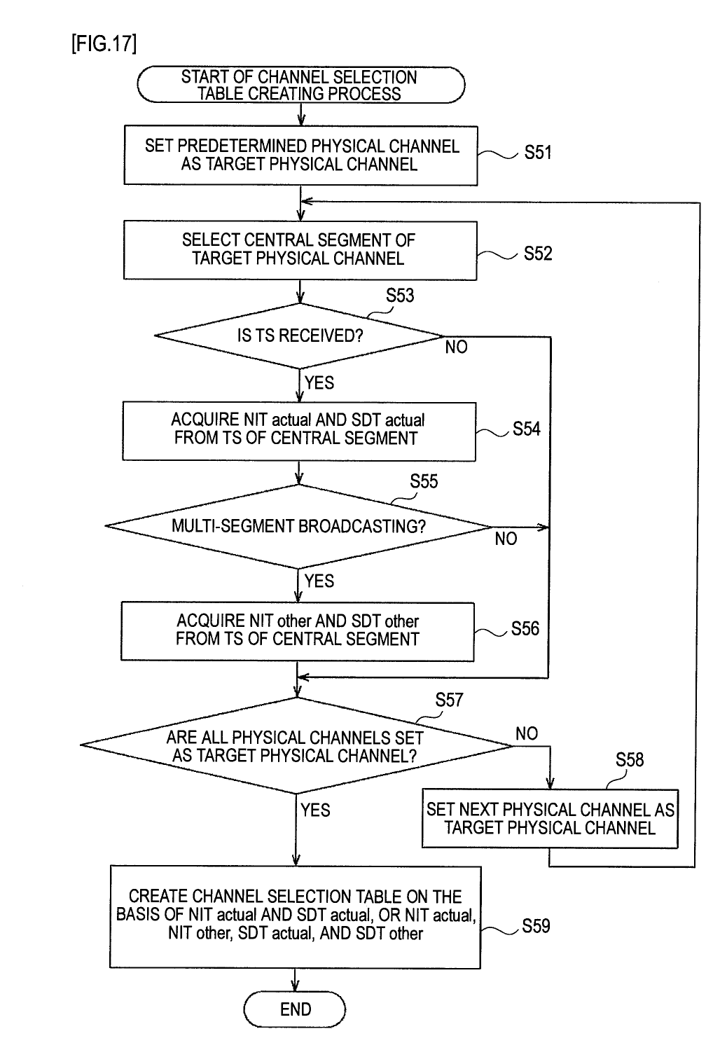

FIG. 17 is a flowchart illustrating the channel selection table creating process in the receiver terminal 33. The channel selection table creating process is started, for example, when a user instructs the acquisition of the channel selection table.

In step S51, the controller 80 sets a predetermined physical channel (for example, a physical channel having the lowest frequency) as a target physical channel to be processed. The controller 80 supplies the frequency of the central segment of the target physical channel as the channel selection information to the tuner 72.

In step S52, the tuner 72 selects the central segment of the target physical channel on the basis of the channel selection information from the controller 80.

In step S53, the tuner 72 determines whether the TS of the central segment of the target physical channel is received and performs the process of step S54 when it is determined that the TS of the central segment of the target physical channel is received.

In step S54, the demultiplexer 73 divides NIT actual and SDT actual from the TS of the central segment of the target physical channel received by the tuner 72 and acquires NIT actual and SDT actual.

In step S55, the demultiplexer 73 determines whether the received TS is a TS of the central segment of the multi-segment broadcasting on the basis of the multi-segment information descriptor of NIT actual acquired in step S54.

When it is determined in step S55 that the received TS is a TS of the central segment of the multi-segment broadcasting, the demultiplexer 73 divides NIT other and SDT other from the TS of the central segment of the target physical channel and acquires NIT other and SDT other in step S56. Then, the process of step S57 is performed.

On the other hand, when it is determined in step S53 that the TS of the central segment of the target physical channel is not received or when it is determined in step S55 that the received TS is not a TS of the central segment of the multi-segment broadcasting, the process of step S57 is performed.

In step S57, the controller 80 determines whether all the physical channels are set as the target physical channel. When it is determined in step S57 that all the physical channels are not set as the target physical channel, the controller 80 sets a next physical channel (for example, a physical channel having a higher frequency) as the target physical channel in step S58 and performs the process of step S52 again. The processes of steps S52 to S58 are repeatedly performed until all the physical channels are set as the target physical channel.

On the other hand, when it is determined in step S57 that all the physical channels are set as the target physical channel, the controller 80 creates the channel selection table on the basis of NIT actual and SDT other, or NIT actual, NIT other, SDT actual, and SDT other acquired by the demultiplexer 73 in step S59.

As described above, the community broadcasting station 32 generates the NIT of the community broadcasting as the multi-segment broadcasting and transmits the TS including NIT actual describing the NIT of the central segment and NIT other describing the NITs of the non-central segments through the use of the central segment. Accordingly, by only receiving the TS of the central segments of the physical channels of the community broadcasting, the receiver terminal 33 can recognize the channel selection information of all the community broadcasting from NIT actual and NIT other included in the received TS.

Since the community broadcasting station 32 transmits the NITs of the non-central segments as NIT other defined in the existing terrestrial digital broadcasting, the community broadcasting can be matched with the method and system of the existing terrestrial digital broadcasting, there guaranteeing the inter-operability.

On the contrary, when the NITs of the non-central segments along with the NIT of the central segment are transmitted as NIT actual, the receiver terminal 33 may cause an erroneous operation. This is because it is not defined in the existing terrestrial digital broadcasting that NIT actual includes the NITs of the segments other than the corresponding segment.

The receiver terminal 33 receives the TS of the central segment of the community broadcasting transmitted from the community broadcasting station 32 and extracts NIT actual and NIT other from the TS. The receiver terminal 33 creates the channel selection table on the basis of NIT actual and NIT other. Accordingly, by only receiving the TS of the central segments of the physical channels of the community broadcasting, the receiver terminal 33 can recognize the channel selection information of all the community broadcasting transmitted on the basis of NIT actual and NIT other included in the received TS.

The receiver terminal 33 can be embodied by adding a function of extracting both NIT actual and NIT other from the TS of the central segment of the multi-segment broadcasting and a function of registering the channel selection information of the multi-segment broadcasting in the channel selection table on the basis of NIT actual and NIT other to the existing receiver terminal 100. Accordingly, according to the receiver terminal 33, it is possible to suppress an increase in cost necessary for coping with the community broadcasting.

In the above description, SDT other is disposed in the TS of the central segment. However, when it is not necessary to display the service names in the receiver terminal 33, SDT other may not be disposed. For example, when a user instructs a channel selection object by instructing the movement of the physical channel by the use of up and down buttons in the receiver terminal 33, SDT other may not be disposed.

In the above description, one NIT other is disposed for the entire non-central segments. However, the non-central segments may be classified into plural groups (for example, groups for each community broadcasting station 32 as a broadcast source) and NIT other may be disposed for each group.

The above-mentioned processes of the community broadcasting station 32 and the receiver terminal 33 may be performed by hardware or by software. When the processes are performed by software, the programs constituting the software are installed in a computer. Here, examples of the computer include a computer assembled into dedicated hardware and a personal computer capable of performing various functions by installing various programs therein.

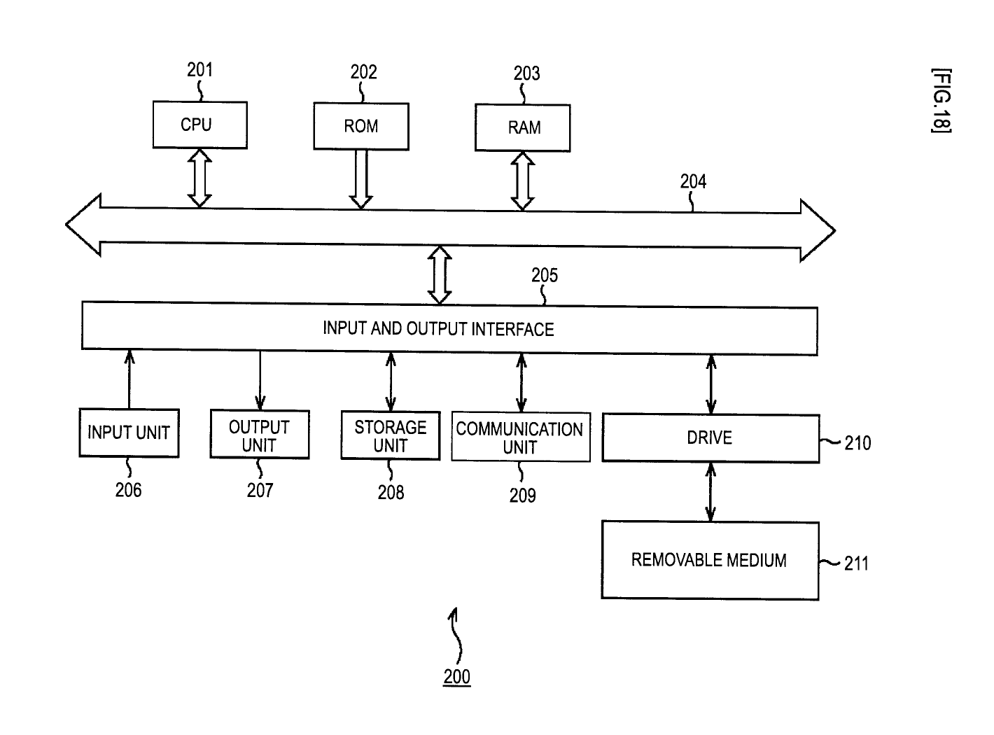

FIG. 18 is a block diagram illustrating the hardware configuration of a personal computer performing the above-mentioned processes by the use of programs.

In the personal computer 200, a CPU (Central Processing Unit) 201, a ROM (Read Only Memory) 202, and a RAM (Random Access Memory) 203 are connected to each other via a bus 204.

An input and output interface 205 is connected to the bus 204. An input unit 206, an output unit 207, a storage unit 208, a communication unit 209, and a drive 210 are connected to the input and output interface 205.

The input unit 206 includes a keyboard, a mouse, and a microphone. The output unit 207 includes a display and a speaker. The storage unit 208 includes a hard disk or a nonvolatile memory. The communication unit 209 includes a network interface. The drive 210 drives a removable medium 211 such as a magnetic disk, an optical disk, a magneto-optical disk, and a semiconductor memory.

In the personal computer 200 having the above-mentioned configuration, the CPU 201 performs the processes, for example, by loading a program stored in the storage unit 208 into the RAM 203 via the input and output interface 205 and the bus 204 and executing the loaded program.

The program executed by the personal computer 200 (the CPU 201) may be recorded, for example, in the removable medium 211 as a package medium and can be provided. The program may be provided via wired or wireless transmission mediums such as a local area network, the Internet, and digital satellite broadcasting.

In the personal computer 200, the program can be installed in the storage unit 208 via the input and output interface 205 by attaching the removable medium 211 to the drive 210. The program may be received by the communication unit 209 via the wired or wireless transmission mediums and may be installed in the storage unit 208. Otherwise, the program may be installed in advance in the ROM 202 or the storage unit 208.

The program executed by the computer may be a program to be processed in time series in the order described in the invention or a program to be processed in parallel or at a necessary time such as when it is called.

The system in this specification means the entire apparatus including plural devices.

The invention is not limited to the above-mentioned embodiment but can be modified in various forms without departing from the concept of the invention.

### REFERENCE SIGNS LIST

32: COMMUNITY BROADCASTING STATION
33: RECEIVER TERMINAL
51: RELEVANT INFORMATION GENERATING UNIT
57: TRANSMITTER UNIT
72: TUNER
73: DEMULTIPLEXER
80: CONTROLLER

1. A transmitter comprising:
generation means for generating representative channel selection information including information on channel selection of a representative segment of multi-segment broadcasting and non-representative channel selection information including information on channel selection of segments other than the representative segment; and
transmission means for transmitting the representative channel selection information and the non-representative channel selection information through the use of the representative segment.

2. The transmitter according to claim 1, wherein the representative channel selection information includes information on the channel selection of the representative segment and multi-segment information indicating that the representative segment is a segment of the multi-segment broadcasting.

3. The transmitter according to claim 1, wherein the representative channel selection information includes information on the channel selection of the representative segment and a network ID specific to a network corresponding to the representative segment, and
wherein the non-representative channel selection information includes information on the channel selection of the non-representative segments and network IDs other than the network ID included in the representative channel selection information.

4. The transmitter according to claim 3, wherein the segments other than the representative segment are classified into a plurality of groups,
wherein the generation means generates the representative channel selection information and generates the non-representative channel selection information for each group, and
wherein the network ID included in the representative channel selection information and the network ID included in the non-representative channel selection information for each group are different from each other.

5. A transmission method of a transmitter comprising:
a generation step of generating representative channel selection information including information on channel selection of a representative segment of multi-segment broadcasting and non-representative channel selection information including information on channel selection of segments other than the representative segment; and
a transmission step of transmitting the representative channel selection information and the non-representative channel selection information through the use of the representative segment.

6. A program allowing a computer to serve as a transmitter comprising:
generation means for generating representative channel selection information including information on channel selection of a representative segment of multi-segment broadcasting and non-representative channel selection information including information on channel selection of segments other than the representative segment; and
transmission means for transmitting the representative channel selection information and the non-representative channel selection information through the use of the representative segment.

7. A receiver comprising:
reception means for receiving information, which is transmitted through the use of a representative segment of multi-segment broadcasting, including representative channel selection information including information on channel selection of the representative segment and non-representative channel selection information including information on channel selection of segments other than the representative segment;
extraction means for extracting the representative channel selection information and the non-representative channel selection information from the information received by the reception means; and
creation means for creating a table of information on the channel selection of the segments of the multi-segment broadcasting on the basis of the representative channel selection information and the non-representative channel selection information extracted by the extraction means.

8. The receiver according to claim 7, wherein the representative channel selection information includes information on the channel selection of the representative segment and multi-segment information indicating that the representative segment is a segment of the multi-segment broadcasting, and
wherein the extraction means extracts the representative channel selection information from the information received by the reception means and further extracts the non-representative channel selection information when the multi-segment information is included in the representative channel selection information.

9. The receiver according to claim 7, wherein the representative channel selection information includes information on the channel selection of the representative segment and a network ID specific to a network corresponding to the representative segment, and
wherein the non-representative channel selection information includes information on the channel selection of the non-representative segments and network IDs other than the network ID included in the representative channel selection information.

10. The receiver according to claim 9, wherein the segments other than the representative segment are classified into a plurality of groups,
wherein the reception means receives information including the representative channel selection information and the non-representative channel selection information for each group, and
wherein the network ID included in the representative channel selection information and the network ID included in the non-representative channel selection information for each group are different from each other.

11. A reception method of a receiver comprising:
a reception step of receiving information, which is transmitted through the use of a representative segment of multi-segment broadcasting, including representative channel selection information including information on channel selection of the representative segment and non-representative channel selection information including information on channel selection of segments other than the representative segment;
an extraction step of extracting the representative channel selection information and the non-representative channel selection information from the information received in the reception step; and
a creation step of creating a table of information on the channel selection of the segments of the multi-segment broadcasting on the basis of the representative channel selection information and the non-representative channel selection information extracted in the extraction step.

12. A program allowing a computer to serve as a receiver comprising:
reception means for receiving information, which is transmitted through the use of a representative segment of multi-segment broadcasting, including representative channel selection information including information on channel selection of the representative segment and non-representative channel selection information including information on channel selection of segments other than the representative segment;
extraction means for extracting the representative channel selection information and the non-representative channel selection information from the information received by the reception means; and
creation means for creating a table of information on the channel selection of the segments of the multi-segment broadcasting on the basis of the representative channel selection information and the non-representative channel selection information extracted by the extraction means.
